(19) United States
(12) Patent Application Publication
(10) Pub. No.: US 2014/0330666 A1
(43) Pub. Date: Nov. 6, 2014

(54) METHODS AND APPARATUS FOR PROVIDING AN ELECTRONIC COMMERCE PLATFORM

(71) Applicant: MYLISTING INC., Arriba, CO (US)

(72) Inventor: Kevin Nathan Saffer, Arriba, CO (US)

(21) Appl. No.: 14/331,717

(22) Filed: Jul. 15, 2014

Related U.S. Application Data
(63) Continuation of application No. 13/450,075, filed on Apr. 18, 2012.
(60) Provisional application No. 61/477,103, filed on Apr. 19, 2011.

(51) Int. Cl. G06Q 30/08; G06Q 30/06

(52) U.S. Cl. CPC G06Q 30/08; G06Q 30/0613
USPC 705/26.3

(57) ABSTRACT

A method performed on a computer server system hosting an electronic commerce platform is provided for incentivizing provision of sales assistance services by customer service representatives to sellers of products or services on the platform, without inflating product or service pricing with commission fees or artificially lowering product pricing. Thereby a number of sellers participating on the platform may be increased. A registration is received from a seller for access to the platform. The seller is charged a periodic fee for access to features of the platform additional to sale listings. A listing of a product or service for sale by the seller is received on the platform. The registration from the seller is associated with a customer service representative indicated as providing assistance services to the seller in listing the product or service for sale on the platform. A transaction for a purchase of the product or service is processed. All funds received from the purchase of the product or service are remitted to the seller. The representative is then compensated for the assistance services on a recurring basis with a portion of the periodic fee rather than a transaction fee on the funds received from the purchase.

### CROSS REFERENCE TO RELATED APPLICATIONS

This application claims priority to U.S. patent application Ser. No. 13/450,075 filed 18 April 2013 entitled “Method and apparatus for providing an electronic commerce platform,” which further claims benefit under 35 U.S.C. §119(e) to U.S. provisional application No. 61/477,103 filed 19 Apr. 2011 entitled “Method and apparatus for providing an electronic commerce platform,” which are hereby incorporated by reference in their entirety.

### TECHNICAL FIELD OF THE DISCLOSURE

The present disclosure relates to systems, methods, and apparatus for electronic commerce. In particular, the present disclosure relates to an Internet-based electronic marketplace platform supported by a team of customer service representatives.

### BACKGROUND OF THE DISCLOSURE

Electronic marketplaces allow users to interactively participate in the purchase or sale of an item via electronic communication over a network, such as the Internet. The electronic marketplace serves as a platform for bringing potential buyers and sellers together, allowing sellers to list, and buyers to search for, a diverse variety of items at a common electronic location, such as a website. Online marketplace operators are expanding rapidly because inventories, warehouses, and large support staff are not required, and because purchases and transactions are largely driven by users of the site.

Current electronic marketplaces follow a typical format. The seller posts an item for sale at auction or for a fixed price, along with a description of the item. Prospective buyers then indicate interest in the item, either entering a bid on the item, in the case of an auction format, or in the alternative tendering the seller's stated fixed price. For auctions, once the auction period ends, the auction closes and a transaction occurs between the buyer and seller, with the buyer who submitted the highest bid tendering the amount bid.

One example of an existing centralized electronic bulletin board format marketplace is Craigslist.com®, which includes listings in categories similar to the classified section of a newspaper. One example of a centralized auction service is Ebay®, where users bid on items posted by sellers for a given period of time. Users who list items or information on these websites are often charged a fee for the listing service in order to shoulder the costs of building, maintaining, and advertising the website, and also to turn a profit for investors in the website. However, when sellers are charged fees to list items on these websites, the cost of the listing is often passed on to the buyer through an artificially inflated price over what the price would have been, had the seller not been charged a listing fee.

A wide variety of goods and/or services can be offered for sale using electronic marketplaces, making them an attractive means for sellers to list items for which it would be difficult to market through conventional methods (e.g., estate sales, pawn shops, fleas markets, yard sales, classified ads, etc.). By way of example only, such goods may include consumer items such as cars, televisions, other electronics, household items, office equipment, and furnishings, among many other things. Such services may include household services, business services, personal services, and marketing services, among many other things.

In order for a good or service to command the best sale price, it is commonly understood that a seller should provide a detailed description of the good or service being sold when presenting the product for sale. This facilitates the sale in a more valued manner, where prospective buyers are more confident that the item to be purchased meets with their expectations, as they are otherwise not able to physically inspect the item prior to purchase as is the case in tradition brick-and-mortar marketplaces. Product descriptions, images thereof, and manuals therefor, etc., may thus all be gathered to facilitate an effective sale at a maximized price.

Often times, however, individuals and small companies do not have adequate knowledge or understanding of computers, the Internet, or the specific marketplace website to successfully list items for sale. Many people still do not know how to operate a computer, much less navigate the world wide web in a manner sufficient to appropriately list an item for sale through an electronic marketplace. Thus, in many instances, people desirous of selling particular items are effectively excluded from access to diverse potential buyers who may be interested in paying top-dollar for their product, especially in the case of unique or hard-to-find items in traditional marketplaces. Furthermore, even if the seller is savvy enough to access the marketplace website and list their item for sale in a manner sufficient to attract numerous buyers, there may be other aspects of the eventual resulting transaction, such as drafting a contract for sale, insurance and warranty agreements, escrow, and shipping and handling arrangements, among may other things, that are difficult for the seller to navigate without assistance.

Thus, there is a need in the art for an electronic marketplace platform that allows users to list items without fees, to prevent artificial price inflation. There is further a need in the art for such an electronic marketplace platform that provides customer service assistance to users in listing their items for sale. There is still further a need in the art for such an electronic marketplace that provides after-sale services to buyers and sellers to assist in completing the transaction. These and other benefits may be realized by embodiments of the present disclosure, which will be described in the detailed description that follows, in addition to the figures associated therewith.

### BRIEF SUMMARY OF THE DISCLOSURE

In one embodiment, disclosed herein is a method of electronic commerce on a computer-implemented electronic marketplace platform, which may include receiving, through an electronically implemented listing module of the electronic marketplace platform, electronic information regarding an item to be listed for sale; categorizing, through an electronically implemented categorization module of the electronic marketplace platform, the item to be listed for sale base at least in part on the received information; and receiving, through an electronically implemented query module of the electronic marketplace platform, an electronic query regarding an item to be purchased. The electronic information may be generated by a user of the electronic marketplace platform with the assistance of a customer service representative. The electronic information generated with the assistance of the customer service representative may be received into the listing module without a fee being charged to the user. The method may also include providing the user with an additional service in connection with the listing of the item for sale on the electronic marketplace platform, wherein the user is charged a fee for the additional service.

In some variations of this embodiment, the electronic query may be generated by a second user of the electronic marketplace platform with the assistance of a customer service representative. The electronic query generated with the assistance of the customer service representative may be received into the query module without a fee being charged to the second user. Furthermore, the user may be a seller of the item to be listed for sale, and wherein the second user is a buyer of the item to be listed for sale.

In other variations of this embodiment, the additional service includes providing a contract for sale of the item. The additional service may include providing information regarding insurance or warranties for the item. In some variations, the customer service representative does not receive compensation for assisting the user in generating the electronic information, but rather the customer service representative does receive compensation in connection with the fee charged to the user for the additional service. The customer service representative may also receive compensation in connection with continuing service agreements for which the user may be charged a periodic fee. This compensation may include a one-time payment, or it may include one or more periodic payments.

In further variations of this embodiment, the electronic information may include a product description of the item. Alternatively, the electronic information may include a parameter of sale. Further alternatively, the electronic information may include a price of the item. The electronic query may include a search term. The search term may be associated with a category created by the categorization module. A listing of items for sale in the category associated with the search term may be provided to a second user.

In still further variations of this embodiment, the user may access the electronic marketplace platform using a client device connected to a network, wherein the electronic marketplace platform may also be connected to the network. The network may be the Internet, and the user may access the electronic marketplace platform using a web browser provided on the client device. The client device may be a handheld device connected to a wireless network. Furthermore, the variations of the present embodiment may include receiving payment information into the electronic marketplace platform using a purchasing module.

In another embodiment, disclosed herein is method of electronic commerce on a computer-implemented electronic marketplace platform, which may include selecting an item to be listed for sale on the electronic marketplace platform; providing information regarding the item to be listed, in electronic format, to a listing module of the electronic marketplace platform from an electronic client device, using an electronic network; and receiving assistance from a customer service representative in connection with providing information regarding the item to be listed. In some variations, a fee is not charged for providing information regarding the item to be listed or for receiving assistance from the customer service representative, and the customer service representative does not receive compensation for the assistance. The method may also include receiving information in electronic format from a purchasing module of the electronic marketplace platform, through the electronic client device and using the electronic network, regarding the purchase of the listed item; and receiving additional services provided by the customer service representative in connection with the purchase of the listed item. In some variations, a fee is charged to the user for the additional service, and compensation may be provided to the customer service representative in connection with the provision of the additional service.

In yet another embodiment, disclosed herein is a computer-implemented system for providing electronic commerce, which may include a computer-implemented electronic marketplace platform, and the platform may include a server, a data storage device provided in operable connection with the server, and a software application provided in operable connection with the data storage device and the server. The software application may include electronic instructions for providing: a listing module, wherein the listing module is configured to receive electronic information regarding an item to be listed for sale on the electronic marketplace platform; a categorization module, wherein the categorization module is configured to categorize the item to be listed for sale based at least in part on the received electronic information; and a query module, wherein the query module is configured to receive electronic queries regarding an item desired to be purchased. The electronic information regarding an item to be listed for sale may be generated with the assistance of a customer service representative, and a fee may not be charged for the receiving of electronic information into the listing module or for the assistance of the customer service representative. Additional services may be provided in connection with the listing of the item for sale on the electronic marketplace, and a fee may be charged in connection with the additional services.

In yet another embodiment, disclosed herein is a method of electronic commerce on a computer-implemented electronic marketplace platform, wherein the electronic marketplace platform comprises an electronic listing module configured for receiving listing information regarding one or more items to be listed on the platform from one or more sellers, an electronic categorization module configured for categorizing the one or more items to be listed on the platform based at least in part on the listing information, and an electronic query module configured for receiving a query from one or more potential buyers regarding an item listed for sale on the platform, wherein the method may include engaging a customer service representative to assist the one or more sellers in accessing or using the electronic marketplace platform or the listing module of the electronic marketplace platform; not providing compensation to the customer service representative for assisting the one or more sellers; providing one or more additional services to the one or more sellers on a continuing subscription basis in connection with the one or more sellers' use of the electronic marketplace platform, wherein the one or more sellers was offered the subscription to the one or more additional services by the customer service representative; and providing compensation on a periodic basis to the customer service representative for the one or more sellers' subscription to the one or more additional services. In this embodiment, the method may further include providing additional compensation to a first customer service representative for additional services offered to sellers by additional a second customer service representative introduced to the platform by the first customer service representative.

In another exemplary implementation, a method is provided for incentivizing provision of sales assistance services by customer service representatives to sellers of products or services on an electronic commerce platform, without inflating product or service pricing with commission fees or artificially lowering product pricing. Thereby a number of sellers participating on the electronic commerce platform may be increased. The method includes the following steps performed on a computer server system hosting the electronic commerce platform. A registration is received from a seller for access to the electronic commerce platform. The seller is charged a periodic fee for access to features of the electronic commerce platform additional to sale listings. A listing of a product or service for sale by the seller is received on the electronic commerce platform. The registration from the seller is associated with a customer service representative indicated as providing assistance services to the seller in listing the product or service for sale on the electronic commerce platform. A transaction for a purchase of the product or service is processed. All funds received from the purchase of the product or service are remitted to the seller. The customer service representative is then compensated for the assistance services on a recurring basis with a portion of the periodic fee rather than a transaction fee on the funds received from the purchase, thereby avoiding impact to product or service pricing while still incentivizing the provision of sales assistance services by the customer service representative to the seller by providing compensation.

In another exemplary implementation, a method is provided for incentivizing provision of sales assistance services by customer service representatives to sellers of products or services on an electronic commerce platform, without inflating product pricing with commission fees or artificially lowering product pricing. Thereby a number of sellers participating on the electronic commerce platform may be increased. The method includes the following steps performed on a computer server system hosting the electronic commerce platform. A registration is received from a seller for access to the electronic commerce platform. A listing of a product or service for sale by the seller is received on the electronic commerce platform. The registration from the seller is associated with a customer service representative indicated as providing assistance services to the seller in listing the product or service for sale on the electronic commerce platform. The seller is charged a service fee for additional services provided by the customer service representative not directly associated with the listing of the product or service on the electronic commerce platform. A transaction for a purchase of the product or service is processed. All funds received from the purchase of the product or service are remitted to the seller. Then, the customer service representative is compensated for the assistance services with a portion of the service fee rather than a transaction fee on the funds received from the purchase, thereby avoiding impact to product or service pricing while still incentivizing the provision of sales assistance services by the customer service representative to the seller by providing compensation.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims, it is believed that the disclosure will be better understood from the following description taken in conjunction with the accompanying figures, in which:

FIG. 1 is an example illustration of the interactions between an electronic marketplace platform in accordance with the present disclosure and the parties-at-interest thereto, including sellers, buyers, and customer service representatives.

FIG. 2 is an example diagram of an electronic network of devices that may be used in connection with an electronic marketplace platform in accordance with the present disclosure.

FIGS. 3a and 3b are further example diagrams of an electronic network of devices that may be used in connection with an electronic marketplace platform in accordance with the present disclosure.

FIGS. 4a-e are example illustrative screenshots of certain aspects of an electronic marketplace platform in accordance with the present disclosure as may be provided through an Internet accessible web browser to users thereof.

FIG. 5 is an example compensation plan for compensating a customer service representative based upon platform revenue.

FIG. 6 is an example flowchart illustrative of a method of using an electronic marketplace platform in accordance with the present disclosure.

FIG. 7 is an example flowchart illustrative of a method of compensating customer service representatives in connection with an electronic marketplace platform in accordance with the present disclosure.

### DETAILED DESCRIPTION

### Brief Overview of the Disclosure

The present disclosure relates to novel systems, methods, and apparatus for electronic commerce. In particular, the present disclosure describes a novel Internet-based electronic marketplace platform that may be supported by a team of customer service representatives. In one embodiment, an electronic marketplace platform is provided to allow a plurality of users (hereinafter collectively referred to as “sellers”) to list products and services for sale thereon. The listed items for sale may be categorized into one or more categories or subcategories. The electronic marketplace platform may also allow another plurality of users (hereinafter collectively referred to as “buyers”) to search the platform for items listed for sale by the sellers, using a query function provided in connection therewith. If a buyer finds an item that they wish to purchase from a seller, the electronic marketplace platform may allow the buyer to tender a bid or offer for the product. The buyer and seller may then complete the transaction using a payment interface that may be provided by the platform, or by using means outside of the platform.

In some embodiments, customer service representatives associated with the electronic marketplace platform may provide assistance to sellers in connection with accessing and using the platform, and in connection with listing items for sale on the platform, as it will be appreciated that many people are not technologically savvy enough to effectively use such Internet-based services. In further embodiments, customer service representatives associated with the electronic marketplace platform may offer additional services to the sellers in connection with the transaction between seller and buyer, including, for example, contracts for sale regarding the transaction, insurance and warranties regarding the transaction, and other services that may or may not directly relate to the transaction.

In some embodiments, sellers are not charged a fee for accessing or listing items for sale on the electronic marketplace platform, regardless of whether a customer service representative is employed to assist the seller in that regard. In other embodiments, buyers are not charged a fee for querying the platform or tendering a bid or offer for the purchase of a listed item, regardless of whether a customer service representative is employed to assist the buyer in that regard. In still further embodiments, sellers are charged a fee for the use of the aforementioned additional services offered by the customer service representatives, and the customer service representatives may be provided compensation in connection with such additional services that are purchased by the seller. The customer service representative may also receive compensation in connection with continuing service agreements for which the user may be charged a periodic fee. This compensation may include a one-time payment, or it may include one or more periodic payments. Continuing service agreements may include agreements for the continued provision, e.g., on a weekly, monthly, yearly, etc. of the aforementioned additional services for which a fee is charged to the seller.

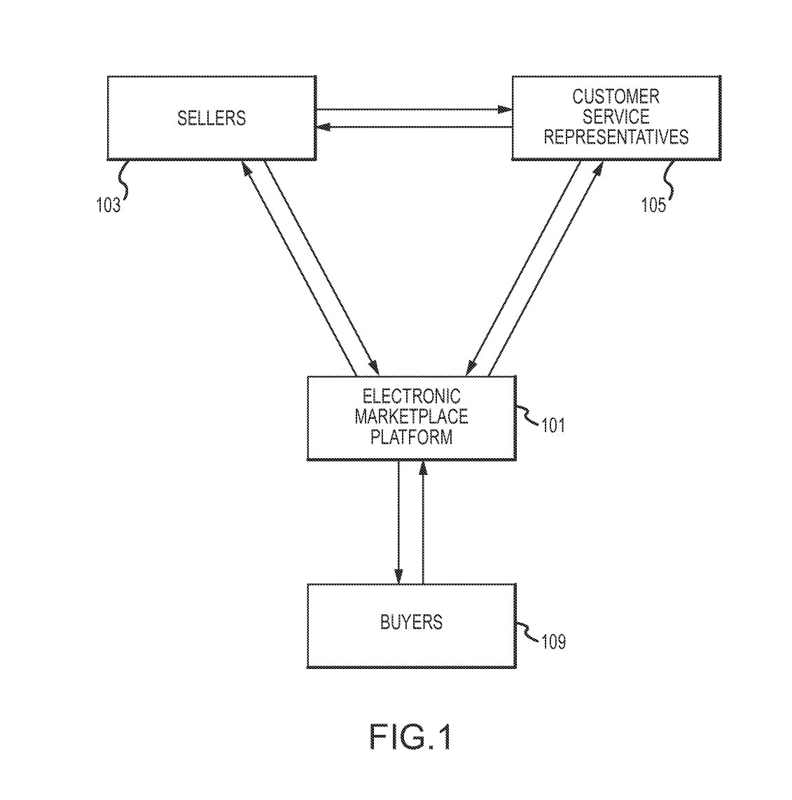

In one embodiment, FIG. 1 presents a conceptual illustration of the interactions between the parties-at-interest, including sellers 103, buyers 109, and customer service representatives 105, and the systems of the electronic marketplace platform of the present disclosure. As shown in FIG. 1, the electronic marketplace platform 101 may both receive information from and send information to one or more sellers 103, via an electronic network and through the use of one or more client devices. In some embodiments, electronic marketplace platform 101 may receive, from the sellers 103, electronic information regarding one or more items that the sellers 103 desire to list on the electronic marketplace platform 101 for sale. The platform 101, in turn, may provide information to the sellers 103 regarding their listed items, including, for example, item status (purchased or pending sale, etc.), previously purchased items, transaction history and record, seller feedback, and a variety of other information. In some embodiments, sellers 103 list items for sale using the electronic marketplace platform 101 without being charged a fee.

In some embodiments, the electronic marketplace platform may be configured to detect fraudulent or otherwise undesirable sellers, and prevent (permanently or temporarily) such sellers from accessing the platform. For example, sellers who have received one or more negative comments or feedback may be prevented for using the platform in the future. In other examples, the platform may include electronic algorithms to detect pattern of use by sellers that are indicative of fraudulent or otherwise undesirable activity. In further examples, the platform may be manually monitored for fraudulent or otherwise undesirable activity. Other methods of fraud detection, or “policing” the platform, are possible.

As further shown in FIG. 1, the electronic marketplace platform 101 of the present disclosure may receive information from and send information to one or more buyers 109. The platform 101 may allow one or more buyers 109 to submit queries to the platform, via Internet web browser and through the use of a client electronic device, including searches for items that the buyers 109 are interested in purchasing. The electronic marketplace platform 101, in response to a buyer query, may search its electronic systems to determine whether there are any items listed for sale by one or more of the sellers 103 that correspond to the buyer's query, as will be discussed in greater detail below. Such corresponding items listed for sale may then be sent to the buyer 109, in electronic form, for the buyer to examine further. In some embodiments, the buyers 109 query the platform and make offers for the purchase of listed items without being charged a fee.

Both sellers 103 and buyers 109 may interact with the electronic marketplace platform 101 in order to complete a transaction, once a buyer 109 has indicated an interest in purchasing an item that has been listed by a seller 103. Systems of the electronic marketplace platform 101 may provide instructions to the buyer 109 regarding the purchase, which may be based on parameters set by the seller 103, and may facilitate the electronic transaction between the buyer 109 and the seller 103 to complete the purchase, for example, by providing an interface to an electronic payment service.

As further shown in FIG. 1, a plurality of customer service representatives 105 associated with the electronic marketplace platform 101 may have interactions with both the sellers 103 and the electronic marketplace platform 101. As previously discussed, many people are not familiar with the use of the Internet, web browsers, and websites, much less have knowledge about how to properly list items for sale on electronic marketplaces. As such, the customer service representatives 105 may provide information and assistance to sellers 103 in order to assist them in both using the electronic marketplace platform, and also in achieving the best possible price for their listed item by assisting them in providing a sufficient description, and sufficient information regarding their item for sale to attract as many potential buyers as possible. Such assistance may include, for example, assisting sellers 103 in accessing the electronic marketplace platform 101 and creating an account on the electronic marketplace platform 101, assisting sellers 103 in using the various modules and features of the electronic marketplace platform 101, assisting the sellers 103 in listing one or more items on the electronic marketplace platform 101, assisting the sellers 103 in describing and providing information regarding their items to be listed, and assisting sellers 103 in setting the parameters of the sale, including, for example, price, sale period, sale format, and transaction method, among other things. In order to assist the sellers 103 in accomplishing these tasks, customer service representatives 105 may of course have access to the electronic marketplace platform 101, in the same manner as discussed above with regard to the sellers 103, in addition to having other access as will be described in greater detail below. Sellers 103 may be provided the assistance of the customer service representatives 105 in using the platform and listing items for sale without being charged a fee.

While not shown specifically in FIG. 1, it will be appreciated that customer service representatives 105 may also assist buyers 109 in accessing and querying the platform, as well as in tendering bids or offers for the purchase of listed items. Buyers 109 may be provided the assistance of the customer service representatives 105 in this regard without being charged a fee.

Furthermore, the customer service representatives 105 may have additional interactions with the sellers 103 regarding additional services offered in connection with the use of the electronic marketplace platform 101 (i.e., in addition to listing items for sale). Customer service representatives 105 may charge the sellers 103 a fee for, and receive a commission from, these additional services offered in connection with the use of the electronic marketplace platform 101, which may include, but are not limited to, providing information regarding contracts of sale for the transaction, providing information regarding insurance and warranties for items sold, and providing information regarding other documentation, including legal documentation, that may be required to complete a transaction. Furthermore, customer service representatives 105 may offer users of the platform additional services (for a fee) that do not directly relate to a particular sale that may include, but are not limited to, integrated payment processing services, no limitations on the number of item listings allowed, business management services, search/query optimization services, promotional services, and consignment services, among other things.

Electronic Marketplace Platform

Embodiments of the present disclosure may be provided with an electronic marketplace platform. The electronic marketplace platform may include a plurality of electronic modules that allow the platform to perform functions in accordance with the present disclosure. Such functions include, for example, receiving information regarding items to be listed for sale from one or more sellers; displaying information regarding the items listed for sale to one or more buyers; receiving, from the buyers, information regarding an offered purchase price for one or more of the plurality of items listed for sale; and communicating information regarding additional services from one or more customers service representatives to the plurality of sellers and buyers. These and other functions will be described in greater detail below in connection with electronic module(s) of the system that are configured to perform such functions.

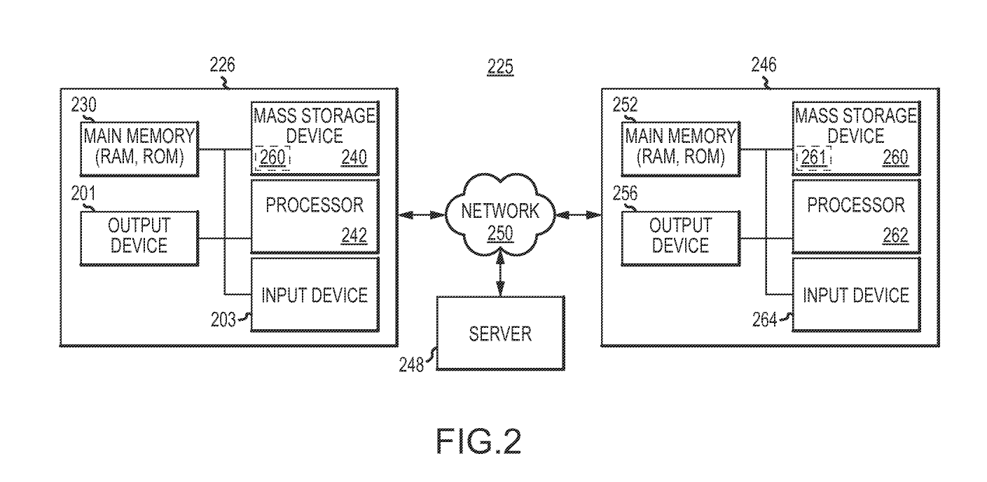

Embodiments of the presently disclosed platform, including the individual electronic modules thereof, may be implemented through one or more computing devices connected with one another through an electronic network. As shown particularly in FIG. 2, a computing device used with the present disclosure may be part of a larger network system 225 of devices. System 225 may include one or more computing devices 226 connected with a network 250, such as the Internet. Computing device 226 can interact with a server 246 in order to input and receive information, for example but not limited to, listing items for sale, searching for items offered for sale, and tendering an offer to purchase an item, as described above.

System 225 may also include the ability to access one or more website servers 248 in order to obtain content through the Internet for use with the electronic commerce systems and methods described herein. While only one computing device is shown for illustrative purposes, system 225 may include a plurality of computing devices 226 and may be scalable to add or remove computing devices to or from a network.

Computing device 226 illustrates components of an embodiment of a suitable computing device for use with the present disclosure. Computing device 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, web-access server, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250, for example, a network connecting the computing devices to the system of the electronic marketplace platform. Input interface 203 may include any device for entering information into computing device 226, such as but not limited to, a microphone, digital camera, video recorder or camcorder, keys, keyboard, mouse, cursor-control device, touch-tone telephone or touch-screen, a plurality of input devices, or any combination of input devices. Output device 201 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser or web-access server may be used to implement or access an electronic marketplace platform, for example, by connecting to the host server of the electronic marketplace platform. Any commercial or freeware web browser or other application capable of retrieving content from a network and displaying pages or screens may be used. In some embodiments, a customized application 280 may be used to provide, access, display, and update information.

A server 246 may also be connected to the network 250. Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keys, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260, for example, for storing information regarding items listed for sale on the electronic marketplace platform, and other data. Any type of data structure can be used, such as a relational database or an object-oriented database.

Processors 242, 262 may, alone or in combination, execute one or more applications 280, 281 in order to provide some or all of the functions, or portions thereof, of the electronic marketplace platform system and method described herein.

In some embodiments, the system may be configured to send and receive information by a handheld device connected to the aforementioned network, including, but not limited to smartphones, PDAs, Internet-enabled cell phones, tablet computers, and other like devices. Information may be sent to, or received from, these devices in the manner described above with regard to personal computers, including all necessary information to access and use the presently described marketplace platform. In one embodiment, handheld electronic devices may access the electronic marketplace platform and receive information in the same website format as a personal computer. In other embodiments, handheld electronic devices may access the electronic marketplace platform and receive information in a format optimized for display on such electronic device, such as an “m.” or a “.mobi” format.

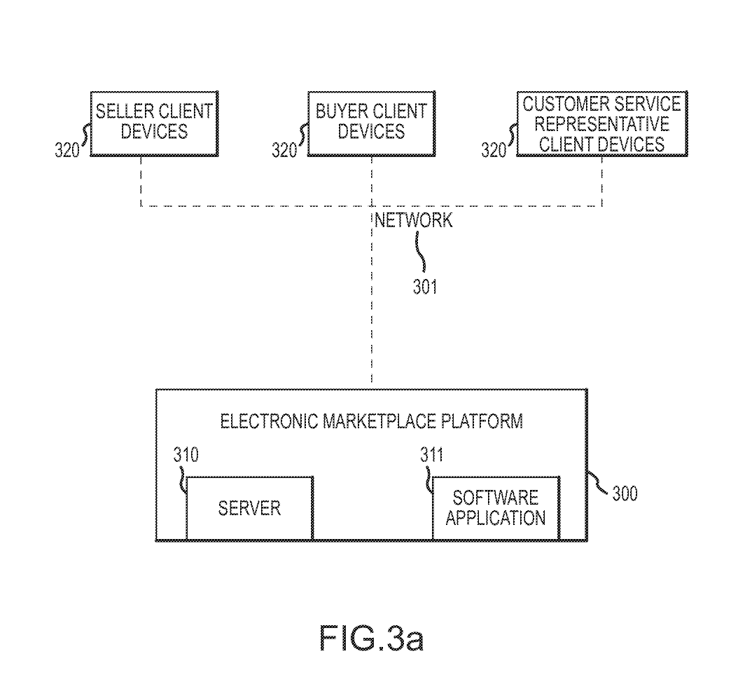

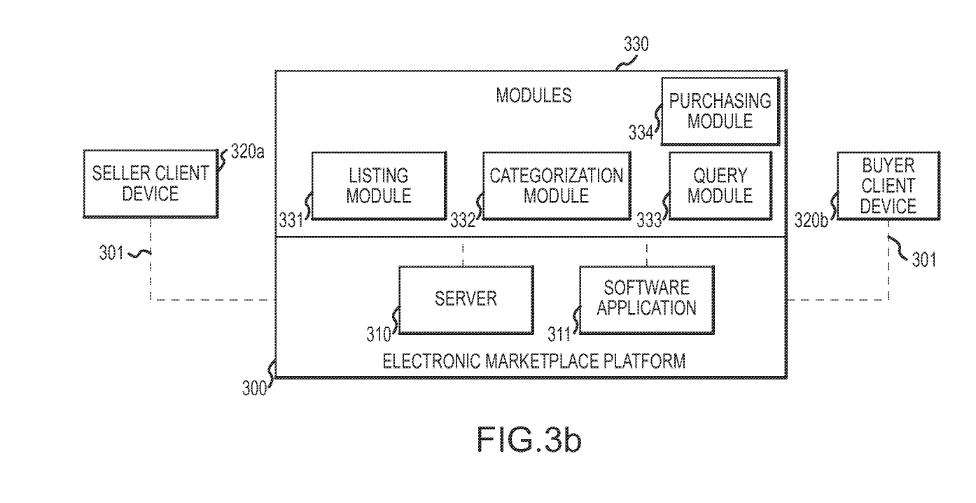

In one embodiment, FIG. 3a shows an example embodiment of an electronic marketplace platform 300 and associated network of devices. The electronic marketplace platform 300 and associated network of devices may include one or more computing devices, for example computing devices 310, 320 connected by a network 301, such as the Internet. The computing devices may include a server 310, and a plurality of client devices 320. The server 310 can store data provided thereto from one or more of the client devices 320, which may include, but is not limited to, information regarding items listed for sale from one or more sellers, information regarding offers to purchase one or more items listed for sale from one or more buyers, and information regarding additional services from one or more customer service representatives.

Accordingly, the server 310, and the electronic marketplace platform 300 in general, may include one or more electronic modules for implementing the various functions of the server 310, including, but not limited to, for example, one or more receiving modules for receiving information regarding items to be listed for sale from one or more sellers; one or more display modules for displaying information regarding the items listed for sale to one or more buyers; one or more additional receiving modules for receiving, from the buyers, information regarding an offered purchase price for one or more of the plurality of items listed for sale; and one or more communication modules for communicating information regarding additional services from one or more customers service representatives to the plurality of sellers and buyers. Particular aspects of the individual modules configured for receiving, displaying, and communicating information in accordance with the present disclosure are discussed in greater detail below.

As discussed above, client devices 320 can be personal computers, cell phones, personal digital assistants (PDAs), smartphones, tablet computers, or any other electronic device capable of communicatively coupling to the network 301. In one embodiment, client devices 320 may access an electronic marketplace platform software application 311 via an Internet web browser application provided at the server 310. Users of the electronic marketplace platform software application 311 can access any of the electronic modules provided by the platform, including those that allow the users to upload and store information regarding the user's marketplace listings, query the server 310 for marketplace listings matching specified parameters, and review the resulting list sets from such queries to select a particular item to acquire, reserve, bid on, or otherwise identify a listing for a transaction with the seller. The software application 311 provided through the Internet web browser by the server 310 may enable each client device 320 to communicate with the server 310 and, possibly, all other client devices 320 through the network 301. Network 301 can be any network, such as the Internet, a LAN, a MAN, a WAN, a wired or wireless network, a private network, or a virtual private network.

In an alternative embodiment to the example shown in FIG. 3a, the electronic marketplace platform may be implemented in a hybrid network. In a hybrid network, a central server, e.g., server 310, stores information on client computers, e.g., clients 320, and responds to requests for that information, but the client computers themselves host the information about the listings that are offered through the electronic marketplace platform, as opposed to the server hosting such information as described above.

FIG. 3b illustrates an example embodiment of an electronic marketplace platform 300 and associated network devices from the perspective of users buying and selling items through the electronic marketplace platform 300. In one embodiment, the electronic marketplace platform 300 systems and methods described herein provide a mechanism for buyers to locate the listings of and contact sellers who have items of interest to such buyers. In one embodiment, a user operating any client device with access to an electronic marketplace platform application 311 provided by the server 310 may wish to sell an item, and any other user operating a client device with access to the electronic marketplace platform application 311 provided by the server 310 may wish to buy the item. As shown in the example of FIG. 3b, the seller is represented by client device 320a, and the buyer is represented by peer client device 320b. A plurality of electronic modules 330 may be provided as part of the electronic marketplace platform 300, for example as part of (or in association with) the software application 311 and/or the server 310, to perform the various functions associated with the buying and selling of items through the platform 300, as will now be described in detail.

In one embodiment, the seller may access a listing module 331 of the electronic marketplace platform through a web browser application via the client device 320a. The seller may provide any necessary listing information to the platform via the listing module 331, including, but not limited to, item description, item price, listing duration, seller contact information, accepted methods of payment, etc. Thereafter, through the operation of the listing module, each item that a seller is interested in selling may be associated with a file residing on the server 310, said file having been created by the information provided from the seller via the network 301 to the listing module 331 of the electronic marketplace platform 300. Alternatively, multiple items can be associated with a single file stored on the server 310, for example, all items associated with a particular seller. Further alternatively or in combination with these approaches, a seller's offerings can be described in an XML or other structured document that is compatible across platforms, for example, personal computers, mobile devices, tablet computers, etc.

In connection with the listing module 331, the electronic marketplace platform 300 of the present disclosure may be provided with a classification module 332. The classification module may be designed so as to function to organize the seller-provided item listings, provided through the listing module 331, into one or more classification schemes. Classifications may be provided for organizational purposes, such that buyers can select a desired classification of the item for which they are searching to more easily identify items of interest for purchase. The classifications may be defined to be appropriate to the particular context or contexts of the electronic marketplace platform 300. For example, in the context of a electronic marketplace platform 300 for pre-owned furnishings, the classification may be according to the room where the furnishings usually reside (e.g., bedroom, living room, kitchen, office, etc.). In the context of a electronic marketplace platform 300 that functions as a marketplace for a particular type of collectible, for example sports trading cards, the classifications may be according to sport and/or team. Depending on the context, the types, categories, or classifications may be more or less specifically defined. Any number or combination of contexts, types, categories, or classifications can be used in connection with any given marketplace platform 300, and in one embodiment, the types, categories, or classifications can be hierarchical in nature. The classification module 332 may determine an appropriate classification for a listed item by, for example, seller input information, wherein the seller identifies an appropriate classification. Alternatively, the classification module 332 may determine an appropriate classification for a listed item by, for example, parsing the item description provided by the seller for identifying information, and then using an algorithm, as may be known in the art, for associating the item with a particular classification based on identified parsed terms in the item description.

Further in connection with the listing module 331, and also the classification module 332, the electronic marketplace platform 300 of the present disclosure may be provided with a query module 333. The query module may be designed so as to function to allow potential buyers to access the platform 300, for example, through client device 320b, and enter search terms descriptive of one or more items that the buyer is desirous of purchasing. Queries may be keyword searches, image searches, or any other query format or method known to those of skill in the art. In one embodiment, the query module 333 may, through one or more algorithms as may be known in the art, associate a particular query with items in one or more classifications, as discussed above with regard to the classification module. In another embodiment, the query module may, through one or more algorithms as may be known in the art, associate a particular query with items having one or more terms in its description (as parsed by the classification module 332). The query module 333 may identify one or more listings in connection with the buyer query, and present such listings to the buyer through a display device associated with the client device 320b.

By way of example, a buyer using client device 320b, may query the query module 333 of the platform 300 for items in a desired category. For example, a buyer who is looking for a used oak bookshelf may query the query module 333 for listings in the office furniture category. In response to the buyer's query, the buyer may receive a list of items for sale in the associated category, or with a description associated with the query. In one embodiment, the query module 333 may provide this information to the buyer by performing a “lookup” by category. In one implementation, the query module 333 may send only a subset of the entire list of that meet the criteria of the buyer's query, depending on the size of the results list, or other considerations. For example, the query module might send only the first 100 or 1000 hits, etc. In one embodiment, the maximum number of hits returned is configurable by the buyer. In another variation, other filtering, grouping, and sorting can be performed on the results of the query.

In some embodiments, the query module 333 as implemented by the electronic marketplace platform 300 may allow a buyer to refine a search after the first query. In the example above, the query module may have returned a list of items for sale in the office furniture category. The buyer may specify additional criteria, such as the characteristics of the office furniture for which the buyer is searching, e.g., “oak bookshelf.” Of course, any criteria can be used in the query by the buyer and/or be included in the information that is conveyed in the search results to the buyer.

In one embodiment, after the query has been performed, the buyer receives details of items that match the buyer's query from the descriptions of items listed by the various sellers (as represented by client device 320a of FIG. 3b). In one embodiment, the details of the items can be displayed on the client device 320b for the buyer to review. The buyer can review the detailed information associated with the item, such as the description of the item, the asking price, the condition of the item, and any other information about the item that the seller uploaded onto the platform via the listing module 331, and the buyer can thereafter select an item that the buyer wants to acquire. In one implementation, the buyer can also review any content, information, or documents related to that seller's offering that the seller has provided. For example, a seller may provide a copy of the warranty document, the service record, a digital photograph, or any other information relevant to a particular item for sale. In another embodiment, the buyer may contact the seller through via the contact information provided by the seller to request more information about the item the buyer may be interested in purchasing.

In one embodiment, the buyer may also receive information about the seller to use in deciding which item from the query the buyer wants to acquire, such as one or more ratings that the seller has obtained from a buyer/seller rating system incorporated into the electronic marketplace platform software application 311. Such a rating system may allow users to check the ratings and comments other buyers or sellers have contributed as feedback about a particular buyer or seller based on a buyer's or seller's unique identification. In another embodiment, ratings can be tracked for particular products and included as described above with the other information transmitted relevant to a particular item for sale.

In one embodiment, the electronic marketplace platform 300 of the present disclosure may be provided with a purchasing module 334, wherein the purchasing module 334 may be designed so as to function to allow the buyer to execute the transaction to purchase one or more desired items from the seller. In one embodiment, the purchasing module 334 may provide instructions on how to execute the transaction to the buyer based on details received from the seller's listing, as discussed above. For example, the instructions may direct the buyer to deposit the payment in an escrow account or with an escrow agent identified by the seller. Alternatively, the seller may direct the buyer to send payment via a network-implemented electronic payment service, for example, but not limited to, Paypal®, or other payment service used for online commerce as will be known in the art. In some embodiments, the purchasing module 334 may provide a link or an interface with such payment means, in order to facilitate the transaction. In other embodiments, the purchasing module may include a “make offer” button and present this option to the user.

Alternatively, the buyer and seller may barter goods or services, or use any other method of exchanging something of value for something else of value. Thus, in some embodiments, the actual sales transaction may occur over a communication channel outside of the electronic marketplace platform, such as electronic mail, telephone, postal service, etc.

As previously discussed, the electronic marketplace platform may be provided to users in electronic format over an electronic network, such as the Internet, to one or more client devices for users to interact with the platform thereon through the use of a web browser application. As such, users of the platform may list items for sale, submit queries, and complete transactions through a variety of web pages provided in connection with the platform. Thus, the platform server, e.g., server 310 of FIGS. 3a and 3b, may be configured to send and receive information, through the functioning of the various modules described above, in web page format.

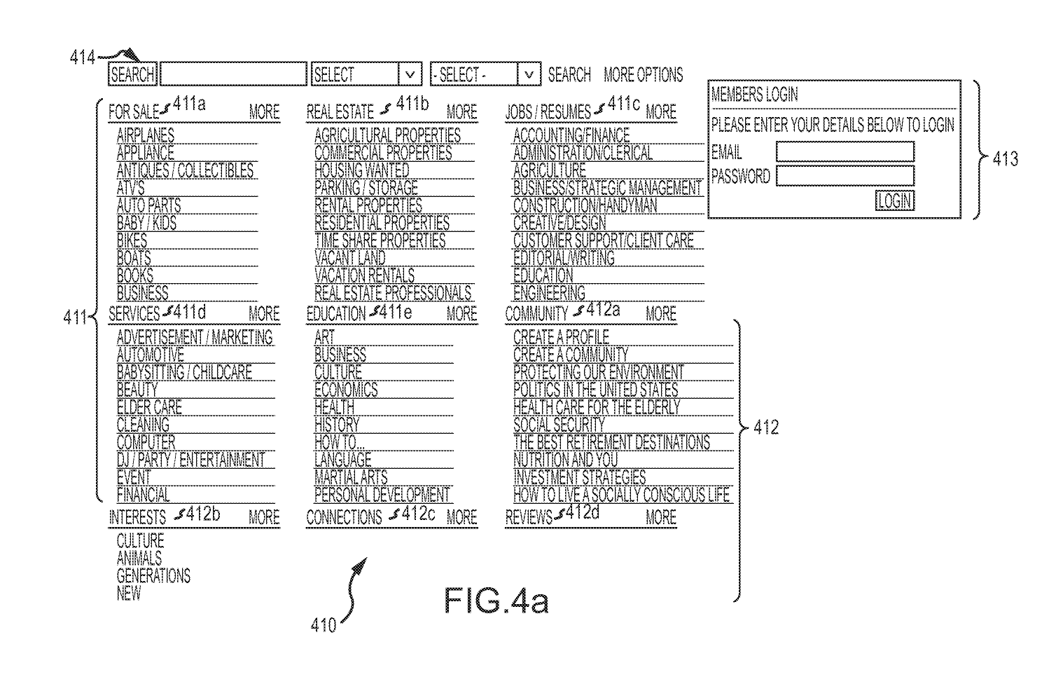

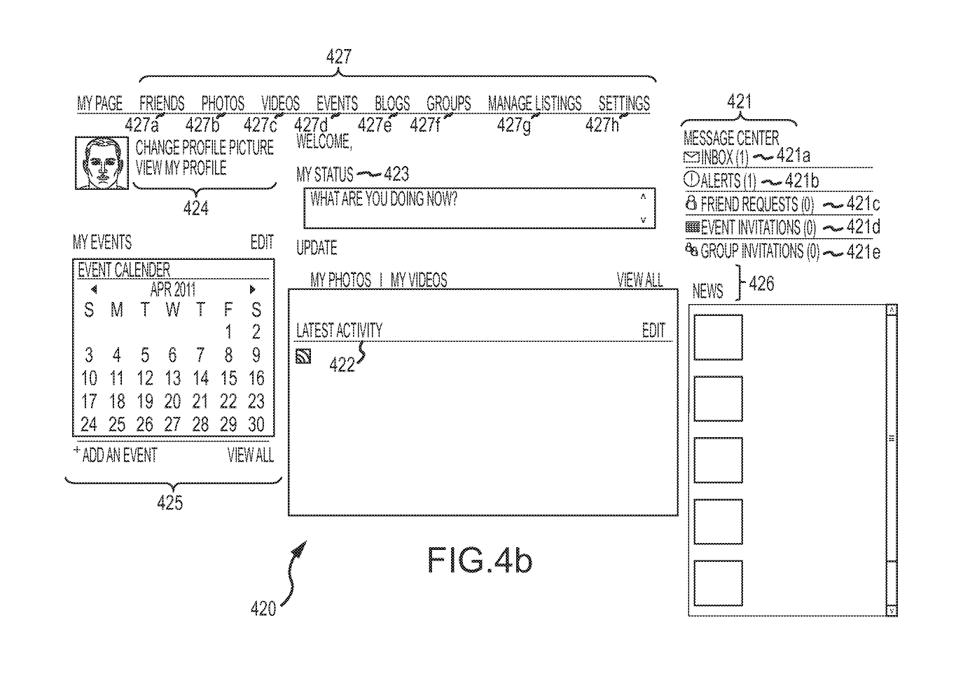

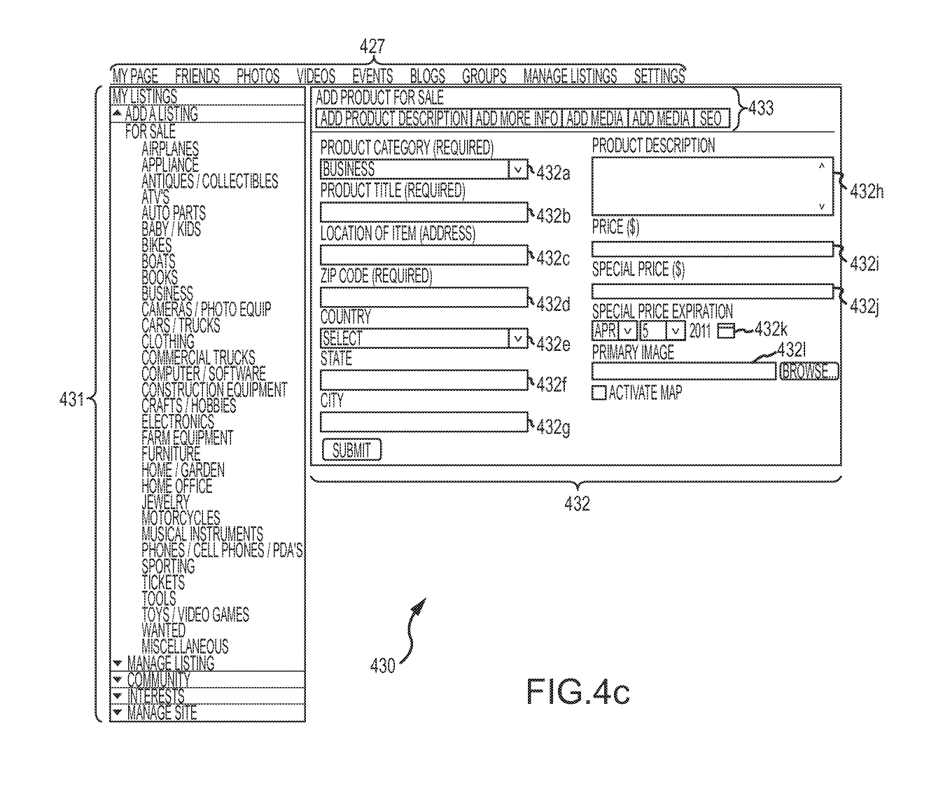

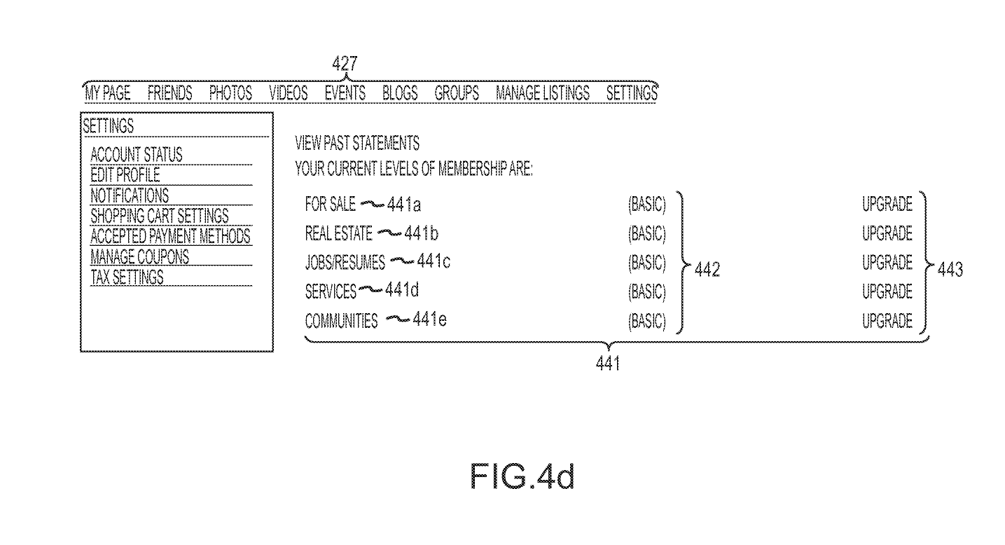

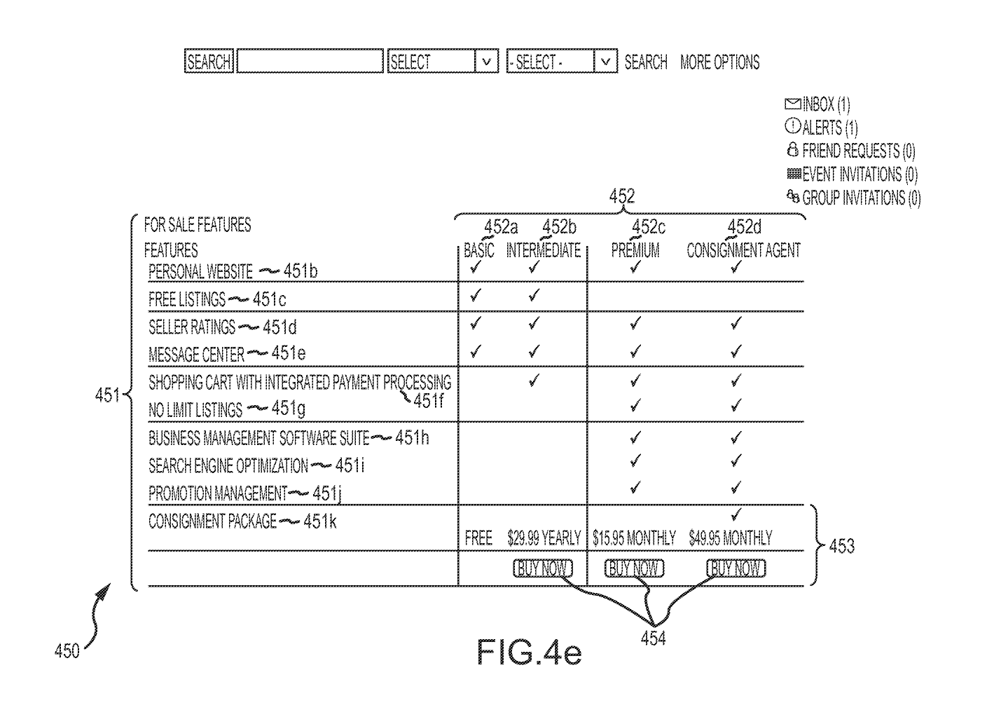

FIGS. 4a-4d are example illustrative screenshots of web pages as may be generated by the electronic marketplace platform and sent to users thereof. FIG. 4a depicts an example “home page” 410 of the electronic marketplace platform in accordance with the present disclosure. As shown thereon, there are a plurality of categories 411 for the listing of items and services for sale, and a plurality of the sub-categories associated therewith. These categories include, for example, “for sale” (411a), “real estate” (411b), “jobs/resume” (411c), “services” (411d), and “education” (411e), among others. Furthermore, from this home page 410, a user of the platform may be able to search through a particular category by clicking on the web-link associated with that category, or one of the sub-categories associated therewith. In some embodiments, a user may also be able to use a search function 414 provided on the home page 410 to find items listed for sale. Further shown on the home page 410 is a “members login” feature 413. Using this feature, users of the platform who have registered accounts therewith may access their account by entering their unique e-mail address, and associated password, or other identifying information. Other features 412 that may be included on a home page 410 of the presently described electronic marketplace platform include, for example, “community” features (412a), “interest features” (412b), “connection” features (412c), and “reviews” features (412d), as shown thereon.

FIG. 4b depicts an example user account “welcome” page 420, as may be presented by some embodiments of the present disclosure. From this user account welcome page 420, a registered user may have access to a message center 421 that links to one or more communication features of the electronic marketplace platform. These communication features may include, for example, an e-mail service, as shown by the “inbox” (421a), “alert” messages (421b), “friend requests” (421c), “event invitations” (421d), and “group invitations” (421e), among other communications features. Further provided on the welcome page 420 is a “latest activity” feature 422, which includes a “recent history” of activity completed on platform, including, for example, recent sale listings, recent purchases, and other transactions. A “status” feature 423, nominated “my status” in the example of FIG. 4b, which may allow the user to provide updates to other users regarding their status, in a manner as is known on social networking platforms. A “user profile” feature 424 may allow a user to add a picture of themselves, or other picture, and provide personal information about themselves that may or may not be made available to other users of the platform. Such personal information can be used in connection with, for example, user associations, directed marketing, and other networking features, as is known in the art. A “calendar of events” feature 425 may be provided as an electronic reminder for various events with which the user is associated, including, for example, planned activities, duration of sales, and bidding deadlines for items of interest, among other things. In some embodiments, a “news” feature 426 may be provided that provides current information to the user regarding the electronic marketplace platform, or other news of general interest. Additionally, a toolbar feature 427 may allow the user to access additional features of the platform, including, for example, “friends” pages (427a), “photograph” posting pages (427b), “video” posting pages (427c), “events” pages (427d), “blogs” pages (427e), and “groups” pages (427f), in addition to providing access to the user's listings (427g) and settings (427h).

FIG. 4c depicts an example product listing page 430 as may be provided by the listing module of the presently disclosed electronic marketplace platform, nominated “Add Product for Sale” as shown therein. The product listing page 430 may include information regarding listing items for sale (“my listings”) 431, which may include a column of categories of items in which the user may list items for sale. As shown in FIG. 4c, the user has selected the “business” category to list an item for sale. In connection therewith, the listings module may present data entry fields 432 for the entry of information regarding the item to be listed. Such information may include, for example but not limited to, “product category” (423a), “product title” (432b), “location of item (address)” 432c, “zip code” (432d), “country” (432e), “state” (432f), “city” (432g), “product description” (432h), “price” (432i), “special price” (432j), “special price expiration” (432k), and an image upload feature (432l), among other things. Fields to enter additional information (433), including, but not limited to, additional media and other electronic attachments or documentation regarding the listing may also be provided.

FIG. 4d depicts an example membership services page 440, where users can view and upgrade their current account/membership status (441). Various levels of membership can be provided in connection with “for sale” services (441a), “real estate” services (441b), “jobs/resume services” (441c), “services” for sale (441d), and platform “community” services (441e), among other things. As shown in FIG. 4d, the current level of membership of the particular user depicted is “basic” in all categories (442), with the option to “upgrade” each respective membership level by clicking on the associated web-link (443) and following the instructions provided in connection therewith.

While certain features of the electronic marketplace platform have been disclosed specifically herein, other features of electronic marketplaces known in the art are not to be deemed excluded from the present disclosure. Rather, it will be appreciated that such additional features of known electronic marketplace platforms may be incorporated into the presently disclosed platform within the level of ordinary skill in the art. As such, the present disclosure is intended to be inclusive with regard to all aspects thereof.

Customer Service Representatives

In some embodiments of the present disclosure, one or more customer service representatives associated with the electronic marketplace platform may provide services to users of the platform. In one example, customer service representatives may provide assistance to sellers in using the electronic marketplace platform. As previously discussed, many people are not technology savvy, and may require assistance and accessing services that are provided over the Internet. These people would not, without assistance, be able to access and use an electronic marketplace platform in accordance with the present disclosure. Thus, customer service representatives may allow persons to use the platform who otherwise would not be able to do so because of limited understanding of computers or the Internet. In turn, these additional persons may offer for sale additional products and services on the platform that otherwise would not have been offered, thereby creating a more robust and diverse marketplace that will attract a broader base of buyers and sellers. Services provided by the customer service representatives in connection with the basic use of the electronic marketplace platform may include, but are not limited to, assistance in accessing the platform through the user's electronic client device, assistance the user in creating a personal account on the platform, assisting the user in accessing a user's account on the platform, assisting the user in accessing the platform using an Internet browser, or other assistance in accessing and using the various features of the electronic marketplace platform.

In further embodiments, customer service representatives may provide assistance to sellers in listing items for sale on the electronic marketplace platform. As previously discussed, even if people are technologically savvy enough to access and open an account on the electronic marketplace platform, they may not have sufficient experience in electronic marketplace platforms to enable them to appropriately list items for sale on the platform. Without such knowledge, inexperienced users may be prone to provide inadequate descriptions that are not sufficient to attract buyers, mis-price products, mis-categorize products, or make other mistakes that serve to prevent the seller from achieving the best sale price possible for the items listed. Artificially low selling prices may in turn discourage sellers from making other sales on the website, which would result in fewer items listed, and a less attractive electronic marketplace. Services provided by the customer service representatives in connection with the listing and sale of items on the electronic marketplace platform may include, but are not limited to, assistance in providing a description of the item, assistance and pricing the item, assistance in providing supporting documentation in connection with the sale of the item, assistance in setting the parameters for the sale, and assistance in providing additional information to prospective buyers in connection with the sale, among other things. For example, in some embodiments, the customer service representative may carry a mobile device that allows access to the platform so that the customer service representative can use the mobile device to take pictures of various items that the user would like to sell and have them listed on the platform before leaving the user's place of business.

Of course, customer service representatives are not limited in providing assistance only to sellers using the electronic marketplace platform of the present disclosure. Rather, customer service representatives may provide assistance to potential buyers in connection with, for example, accessing the platform, entering queries into the query module of the platform, and tendering bids or offers for the purchase of a listed item, among other things.

In addition to these described access and listing services, customer service representatives may offer sellers additional services in connection with the use of the electronic marketplace platform. These additional services may assist the user in various other aspects of the use of the electronic marketplace platform. For example, many sellers may not have access to an appropriate contract for sale for use in connection with items offered for sale. As is known, a contract for sale provides a legal basis, in writing, of the terms of the sale for the parties to the transaction to reference in the future in case a dispute should arise in connection with the sale. Furthermore, some buyers may require insurance or warranties to be taken out or offered in connection with the sale and transportation of items purchased. Many sellers will likely not have had previous experience in insuring or warranting sold items. Additionally, customer service representatives may offer sellers additional services in connection with these common needs that are associated with the sale of items on an electronic marketplace platform. Services provided in connection therewith may include anything from providing basic information to sellers, all the way to providing the actual legal documents to sellers (contracts for sale, insurance agreements, warranties, etc.). Customer service representative may also offer additional services that are not necessarily related to a particular sale, which may include, but are not limited to enhanced payment processing services, no limitations on the number of item listings allowed, business management services, search/query optimization services, promotional services, and consignment services, among other things.

In some embodiments, customer service representatives may be engaged to assist sellers through seller initiated contact, for example, by contacting a customer service center by phone, e-mail, post, etc. In other embodiments, customer service representatives may be engaged to assist sellers by court order, for example, through an estate sale, bankruptcy liquidation, etc. In still further embodiments, customer service representative may seek to be engaged to assist sellers by direct solicitation, for example, door to door contact, telephone marketing, e-mail marketing, advertisements, etc. It will be appreciated that customer service representatives may be engaged to assist sellers generally in any manner.

The customer services representatives therefore provide convenient human-based services that assist users in achieving the best possible experience in selling their items on the electronic marketplace platform. As will be appreciated, users that have a good experience using the platform are more likely to return to use the platform for their future selling needs, thus creating a broader and more robust electronic marketplace for buying and selling items. It may also open up the marketplace to a broader base of users who can contribute their unique items for sale, or provide a market for such items.

Fee Model

Existing electronic marketplaces charge fees for a variety of services, including listing items for sale (as a fixed fee or as a percentage of the listing price) and for using additional features of the electronic marketplace, such as customer service or assistance features. However, when sellers are charged fees to list items on these electronic marketplaces, the cost of the listing is often passed on to the buyer through an artificially inflated price over what the price would have been, had the seller not been charged a listing fee.

Thus, in one embodiment, the presently described electronic marketplace platform may not charge a fee for listing items for sale. That is, sellers may be able to access the platform, create a user account, and list items for sale without being charged a fee to do so. Additionally, so as not to engage in price discrimination against users who need additional assistance in accessing, using, or listing items on the platform, the electronic marketplace platform may not charge a fee for customer service representative assistance in accessing, using, or listing items on the platform.

In further embodiments, buyers (or potential buyers) of items on the electronic marketplace may not be charged a fee for creating a user account, for submitting a query to the platform, or for tendering an offer or bid for a listed item, whether or not customer service representative assistance is provided in connection with these actions. In this manner, buyers are free to use the platform's query module as desired to look for, find, or tender an offer or bid for the items for which the buyer is searching.

In this manner, by not charging fees to sellers for accessing the platform or for listing items for sale on the platform (with or without the assistance of customer service representatives), and by not charging fees to buyers for accessing the platform, for searching for items to buy on the platform, or for tendering offers or bids for items listed on the platform, both sellers and buyers may be incentivized to make greater use of the presently described electronic marketplace platform, as opposed to existing marketplaces that do charge fees. This incentive may result in a broader base of products being sold, along with a broader market for such products as more users are drawn to use the platform. Further, the prices asked for listed items may more closely resemble the fair market price for such items, without the artificial inflation caused by the listing (or other transaction) fees charged by existing electronic marketplaces.

In some instances, however, a seller may be desirous of upgraded services in addition to the use of the platform, and the listing of items for sale thereon. Such upgraded services may include, but are not limited to, information regarding contracts for sale to be used in connection with the purchase and sale of one or more listed items, insurance and warranty agreements provided in connection with the purchase, sale, and transportation of one or more listed items, information regarding other legal concerns in connection with the transaction, advanced payment processing services, no limitations on the number of item listings allowed, business management services, search/query optimization services, promotional services, and consignment services, among other things.

For users desirous of such additional services, customer service representatives may engage such users, and offer such additional services to the user for a fee. The fee may be structured in a variety of manners, including “a la carte” fees (each service is individually offered for a separate fee) and packaged service fees (where two are more services are bundled together into a single fee). The fees may be associated with services offered for any period of time, for example, fees may be charged for single use of a service, for unlimited monthly use of a service, for unlimited yearly use of a service, etc.

FIG. 4e depicts an illustrative screenshot of a fee-based, upgraded services webpage 450 in connection with the presently described electronic marketplace platform. Users of the platform may be able to access the upgraded services page 450 in the manner discussed above with regard to FIG. 4d (“upgrade” links 443). The webpage 450 may list one or more “for sale features” 451, including but not limited to, “shopping cart with integrated payment processing” (451f), “no limit listings” (451g), “business management software suite” (451h), “search engine optimization” (451i), “promotion management” (451j), and “consignment package” (451k), among other things. Other features of the platform that are free may be listed along with the for sale features, but nominated “free,” to show the user the enhanced value of using the presently described platform over existing platforms. These “free” features include, as discussed above, a personal account (nominated “personal website” (451b)), “free listings” (451c), “seller ratings” (451d), and “message center” (451e), among other things.

Fee-based services may be grouped into one or more packages, as discussed above, and as shown in FIG. 4e as packages 452, including “basic” (452a), “intermediate” (452b), “premium” (452c), and “consignment agent” (452d), among others. As also shown in FIG. 4e, the example fees charged for such additional feature packages (453) range from $29.95 yearly, to $15.95 monthly, to $49.95 monthly. Users may select these additional feature packages by clicking on, or otherwise selecting, an appropriate “buy now” icon 454 as shown.

In some embodiments, customer service representatives may not receive any compensation for assisting users in accessing the platform, or for assisting users in listing items for sale on the platform, as previously described. However, customer service representatives may receive compensation for engaging users to purchase the above-described additional services and features offered in connection with the electronic marketplace platform, including providing information regarding contracts for sale to be used in connection with the purchase and sale of one or more listed items, information regarding insurance and warranty agreements provided in connection with the purchase, sale, and transportation of one or more listed items, information regarding other legal concerns in connection with the transaction, advanced payment processing services, no limitations on the number of item listings allowed, business management services, search/query optimization services, promotional services, and consignment services, among other things. In some embodiments, customer service representatives receive a set compensation amount for an initial purchase of an additional service. In other embodiments, customer service representatives may receive a continuing compensation amount for subscriptions purchased on a periodic basis (e.g., monthly, yearly, etc.). For example, customer service representatives may receive compensation in the form of milestone payments for maintaining sellers' subscription to additional services for a period of time. In further embodiments, customer service representatives receive both compensation for the initial purchase and for the continuing period subscription for additional services.

In some embodiments, a first customer service representative may receive compensation for fee based services ordered by sellers through a second customer service representative who is introduced to the platform by the first customer service representative. It will be appreciated that, with additional customer services representatives, a greater number of sellers may receive assistance in using the platform and listing items for sale on the platform. This, as discussed above, benefits the platform in that there will be a greater market for diverse items, which may attract a broader and more diverse base of buyers. Of course, a greater number of sellers may lead to a greater number of sellers who purchase additional services, and thus there is an incentive for customer service representative to recruit additional customer services representatives to assist additional sellers and to provide additional sellers with additional services for a fee.

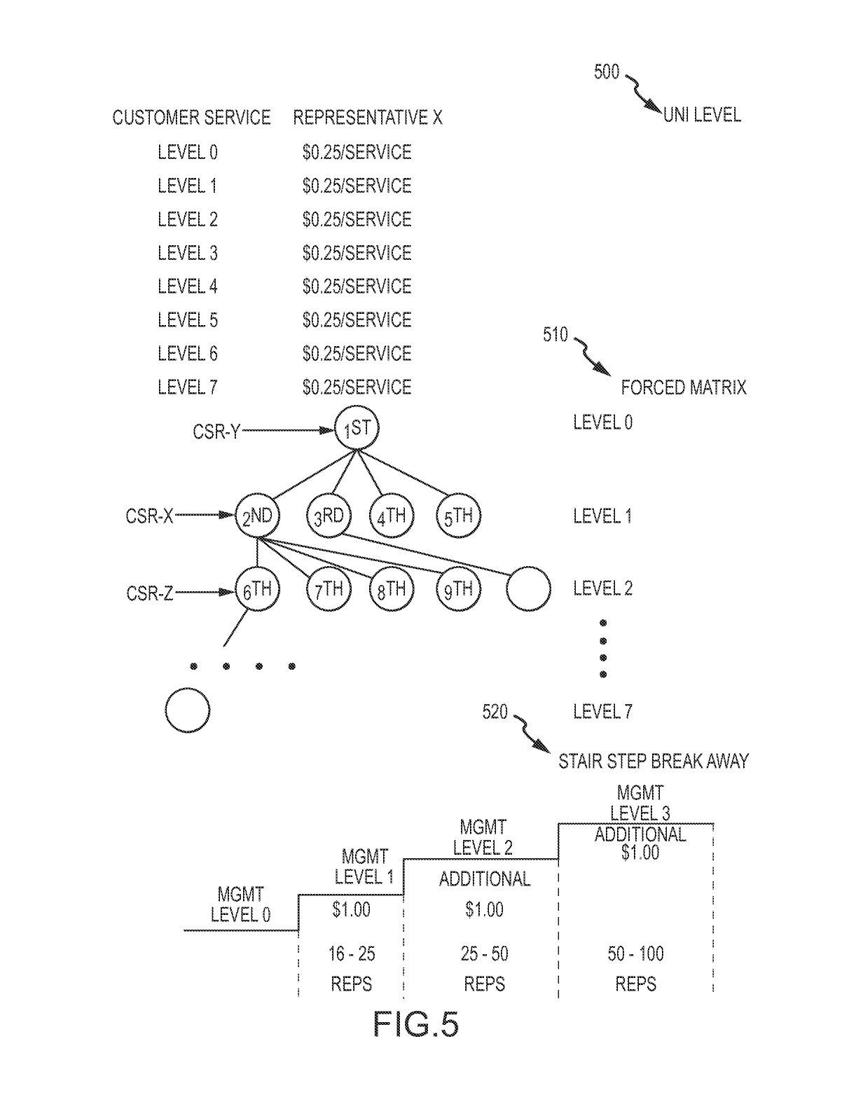

In some embodiments, the customer service representative may receive compensation for platform revenue under several independent compensation portions. FIG. 5 illustrates one possible implementation of a compensation plan for customer service representatives based upon platform revenue with three independent portions 500, 510 and 520. Each of the independent portions 500, 510, and 520 is derived from periodic fee based services provided to end users of the platform (e.g., sellers) and is designed to incentivize different aspects of the platform revenue. These portions are referred to as unilevel portion 500, forced matrix portion 510, and stair step break away portion 520. The for sale 411a portion of the platform (shown in FIG. 4a) is used below to illustrate a plan for compensating the customer service representative, although any of the portions of the platform having fee and non-fee based uses can be used to compensate the customer service representative (e.g., 441b-411e and/or 412a-412e).

Each time a periodic fee (monthly, yearly, etc.) is received from the fee based option of the for sale 411a portion of the platform, it may be divided such that a portion goes directly to customer service representative X that signed the user up to the fee based service (i.e., a customer retention bonus) and a portion would go to customer service representative Y that introduced customer service representative X to the platform. The introduction of customer service representative X by customer service representative Y is sometimes referred to as “sponsoring,” such that customer service representative Y can be said to have sponsored customer service representative X.

Assuming that the periodic fee collected from the user is $10.00 per month for use of the for sale 411a portion of the platform, then the unilevel portion 500 illustrates the portion of each user's fee that is paid to customer service representative X, in this example $0.25 per user per periodic service as a customer retention bonus. In some embodiments, all portions of the platform may be compensated at the same rate as the for sale portion 411a.

Customer service representative X can increase their customer retention bonus by signing up current users to additional fee based services offered by the platform and/or signing up new users to fee based services. In some embodiments, the unilevel portion 500 of the compensation plan has no limit to the total number of periodic end users services that can be compensated in the form of a customer retention bonus. The LEVELS 0-7 shown in the unilevel portion 500 indicate the relationship between customer service representative X and end users of other customer service representatives that are sponsored by customer service representative X. Customer service representative X can be compensated for end user services at each of the levels in the unilevel portion 500. For example, referring to the unilevel portion 500 in conjunction with the forced matrix portion 510 (which shows hierarchical relationship between sponsoring customer service representatives), it can be appreciated that customer service representative X was sponsored by customer service representative Y, and that customer service representative X sponsored customer service representative Z. As part of the unilevel portion 500, customer service representative X would receive a customer retention bonus for each of customer service representative Z's customers on a per end user's periodic service basis because they are in customer service representative X's LEVEL 1. Likewise, customer service representative Y would receive a customer retention bonus for each of customer service representative X's customers on a per end user's periodic service basis because they are in customer service representative Y's LEVEL 1 as well as receive a customer retention bonus for each of customer service representative Z's customers on a per end user's periodic service basis because they are in customer service representative Y's LEVEL 2.

Thus, in this example, customer service representative X would receive $0.25 for periodic service payments from end users that they sign up to the fee based portions of the platform because they are in customer service representative X's LEVEL 0, as well as $0.25 for fee based portions of the platform associated with periodic service payments of end users of customer service representative Z because they are in customer service representative X's LEVEL 1 in this example. Customer service representative Y would receive $0.25 for periodic service payments from end users that they sign up to the fee based portions of the platform because they are in customer service representative Y's LEVEL 0, as well as $0.25 for fee based portions of the platform associated with periodic service payments of end users of customer service representative X because they are in customer service representative Y's LEVEL 1, as well as $0.25 for fee based portions of the platform associated with periodic service payments of end users of customer service representative Z because they are in customer service representative Y's LEVEL 2. As shown, in some embodiments, each customer service representative can receive this type of compensation out to 7 levels of sponsorship. Although this example shows that the portion of the end user fee compensated to the customer service representative is the same at different LEVELS, i.e., $0.25, it should be appreciated that different LEVELS may be compensated differently.

Referring to the forced matrix portion 510, customer service representative X was sponsored by customer service representative Y. This is shown hierarchically in the forced matrix portion 510. In the illustrated embodiment, the number of direct sponsorships is limited to 4, and additional sponsorships over and above the 4 are attributed to one of the 4 originally sponsored customer service representatives. For example, if the 2^{nd} through 5^{th} customer service representatives fill up customer service representative Y's 4 sponsorships, then customer service representative Z would need to be sponsored by one of the 2^{nd} through 5^{th} representatives (in this example customer service representative X or the 2^{nd} representative). Since there may be up to 7 levels in the illustrated embodiment, the forced matrix 510 is referred to as a 4-by-7 matrix. Note that instead of paying for recruitment of additional customer service representatives, the compensation plan seeks to compensate based upon fee based services ordered by end users.

Referring to the stair step break away portion 520, each sponsoring customer service representative may receive a portion of the services based upon the number of sponsorships they manage. The stair step break away portion 520 includes management levels 0-3 (not related to the levels of the forced matrix or unilevel portions 500 and 510), and in some embodiments, these management levels correspond to the number of sponsorships that are within that particular customer service representative's organization. In other embodiments, these management levels correspond to the number of end users in a customer service representative's organization. For example, in embodiments where the management levels correspond to the number of sponsorships, there may be no portion of the end user's service fee that is attributable to a customer service representative that is sponsoring anywhere from 0 to 16 customer service representatives, whereas a portion of the end user's service fee is paid to the customer service representative once they have sponsored 16 to 25 customer service representatives.

In this example, a $1.00 portion of the end user's periodic service fee is paid. As additional levels of management are achieved through the sponsorship of additional customer service representatives, then the portion of the end user's periodic service fee paid to the sponsoring customer service representative may increase. In this example, once the number of representative has sponsored 25 to 50 customer service representatives then an additional $1.00 of the end user's fee (for a total of $2.00 of the end user's fee) may be paid to the sponsoring customer service representative. Likewise, in this example, once the number of representative has sponsored 50 to 100 customer service representatives then an additional $1.00 of the end user's fee (for a total of $3.00 of the end user's fee) may be paid to the sponsoring customer service representative. Note that, in this embodiment, each end user's fee is attributable to a single customer service representative at each management level 1-3 and is independent of payment based upon portions 500 and 510.

In some embodiments, it is possible for customer service representatives to be “passed” by customer service representatives that they have sponsored. Thus, in this example, if customer service representative Z grows their sponsorship to 26 customer service representatives while customer service representative X had 25 sponsorships, then customer service representative Z would pass customer service representative X, and from that time forth, customer service representative Z would receive the level 1 end user fees that would have gone to customer service representative X.

Although the fee model approach has been described, there are embodiments where one or more non-profit organizations may be given access to the fee based portion of the platform without charge.

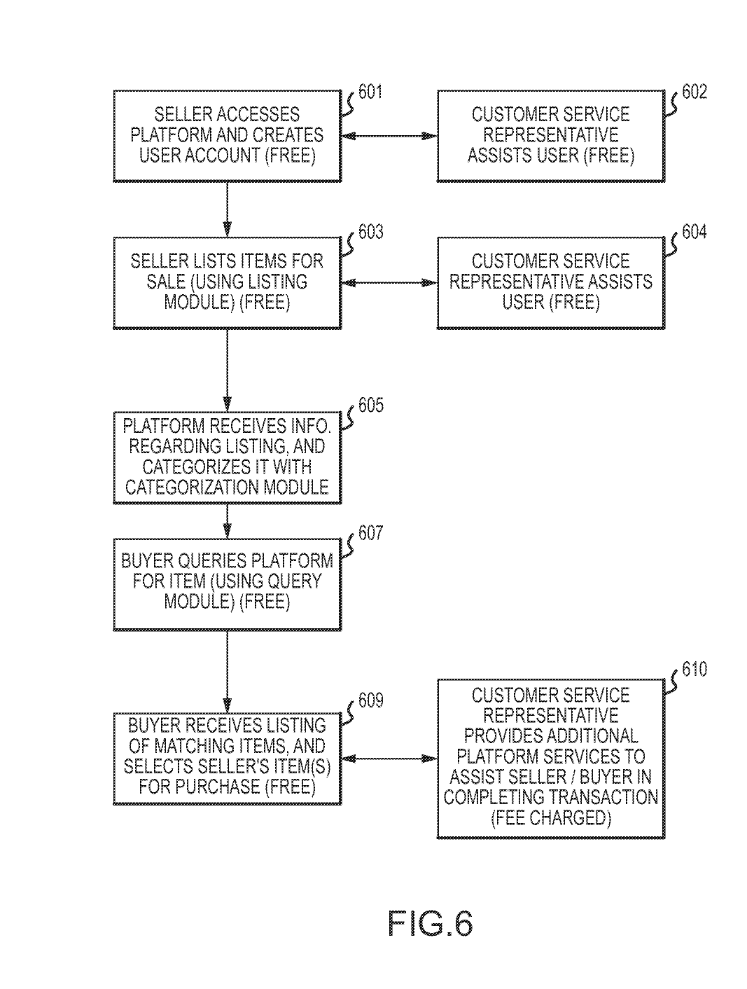

FIG. 6 is a flowchart depicting one embodiment of a method in accordance with the present disclosure, including an indication of fees that are charged (or not charged) in connection therewith. As shown, at block 601, a seller may access the electronic marketplace platform and create a user account, which may include entering information specific to that user, and entering a password to allow for secure access into the account. In some embodiments, there may be no fee charged for the seller to access the platform and to create a user account. In further embodiments, as shown at block 602, one or more customer service representatives may assist the user in accessing the platform and creating a user account. There may be no fee charged for the customer service representative to assist the user in this regard.

At block 603, a seller may enter information into the electronic marketplace platform regarding items that the seller wishes to list for sale. As discussed above, the seller may electronically interact with the listing module of the platform in order to enter this information and send it via electronic network to the platform. In some embodiments, there may be no fee charged for the seller to list one or more items on the electronic marketplace platform for sale. In further embodiments, as shown at block 604, one or more customer service representatives may assist the seller in listing the one or more items for sale on the electronic marketplace platform. Such assistance may include, for example, assistance in entering the description of the item, assistance in setting a price, and assistance in setting parameters for the sale, among other things. There may be no fee charged for the customer service representative to assist the user in this regard.

At block 605, the electronic marketplace platform may receive the information regarding the listed item or items from the seller, via the listing module, and thereafter employ the categorization module to associate the listed item with one or more categories, or one or more parsed terms, as described above. Thereafter, at block 607, a potential buyer may access the electronic marketplace platform and submit a query, searching for one or more items for purchase, through electronic interaction with the query module, as also described above. In some embodiments, there may be no fee charged for the potential buyer to query the platform. In response to the query, at block 609, the potential buyer may receive from the platform a listing in electronic format of items for sale that match, or may be otherwise associated with the potential buyer's query. The buyer may then select from among the listed items presented, and tender an offer or bid to purchase the same, if desired. In some embodiments, there may be no fee charged for the buyer to tender a bid or offer for the purchase of a listed item. Of course, the customer services representatives may also assist the buyer in accessing, searching, and tendering bid and offers for listed items on the platform, all without charging a fee for this assistance.

At block 610, customer service representatives may offer the seller one or more additional services to assist the seller (and also the buyer) in completing the transaction. These additional services may include, for example, providing information regarding contracts for sale to be used in connection with the purchase and sale of one or more listed items, information regarding insurance and warranty agreements provided in connection with the purchase, sale, and transportation of one or more listed items, and information regarding other legal concerns in connection with the transaction, among other things. Other services, not necessarily related to the purchase and sale of any particular item, may also be offered by the customer service representatives, including for example, but not limited to, advanced payment processing services, no limitations on the number of item listings allowed, business management services, search/query optimization services, promotional services, and consignment services, among other things. In some embodiments, a fee may be charged to the seller for the provision of these additional services. Furthermore, the customer service representatives may be provided compensation for selling these additional services to the seller, in one or more of the manners discussed above.

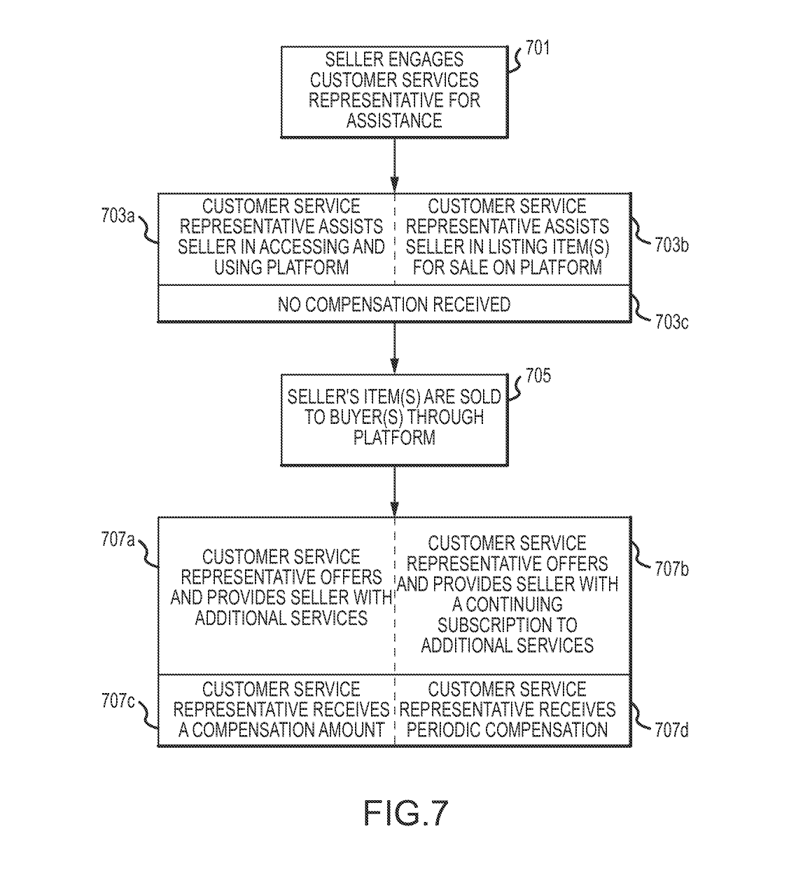

FIG. 7 is a flowchart depicting one embodiment of a method in accordance with the present disclosure, including an indication of commission that is received (or not received) by customer service representatives in connection therewith. At block 701, a seller may engage a customer service representative for assistance, whether seller or representative initiated. At blocks 703a and 703b, the customer service representative may assist the seller in accessing and using the platform, and/or may assist the seller in listing items for sale on the platform. The customer service representatives do not receive any compensation for the services performed in connection with blocks 703a and 703b. Thereafter, at block 705, the seller's items may be sold to one or more buyers, through the operation of the platform as discussed in greater detail above. At blocks 707a and 707b, the customer service representatives offer and provide the seller with additional services, either on a one-time basis in connection with the sale of the items, or on a continuing subscription basis. As shown at block 707c, the customer service representative receives a compensation amount for such additional services provided on a one-time basis. The customer service representative also receives a periodic compensation amount for continuing subscriptions for additional services provided to sellers on a periodic basis, as shown at block 707d. Note that the compensation that the customer service representative receives is based upon selling the services associated with the platform rather than with the actual sale of the product.

Of course, it will be appreciated that the method described above with regard to FIGS. 6 and 7 are intended to be illustrative in nature, and not restrictive, such that additional blocks may be added (or existing blocks removed) without limitation, and/or the order of the blocks may be changed from that presented in FIGS. 6 and 7.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. A method for incentivizing provision of sales assistance services by customer service representatives to sellers of products or services on an electronic commerce platform, without inflating product or service pricing with commission fees or artificially lowering product pricing, and thereby increasing a number of sellers participating on the electronic commerce platform, the method comprising the following steps performed on a computer server system hosting the electronic commerce platform
receiving a registration from a seller for access to the electronic commerce platform;
charging the seller a periodic fee for access to features of the electronic commerce platform additional to sale listings;
receiving a listing of a product or service for sale by the seller on the electronic commerce platform;
associating the registration from the seller with a customer service representative indicated as providing assistance services to the seller in listing the product or service for sale on the electronic commerce platform;
processing a transaction for a purchase of the product or service;
remitting all funds received from the purchase of the product or service to the seller; and
compensating the customer service representative for the assistance services on a recurring basis with a portion of the periodic fee rather than a transaction fee on the funds received from the purchase, thereby avoiding impact to product or service pricing while still incentivizing the provision of sales assistance services by the customer service representative to the seller by providing compensation.

2. The method of claim 1, wherein the listing is received from the customer service representative on behalf of the seller.

3. The method of claim 1 further comprising compensating the customer service representative on a recurring basis with portions of periodic fees paid by additional sellers on the electronic commerce platform associated with sponsored customer service representatives introduced to the electronic commerce platform by the customer service representative.

4. The method of claim 4 further comprising compensating the customer service representative on a recurring basis with portions of periodic fees paid by other additional sellers on the electronic commerce platform associated with additional sponsored customer service representatives introduced to the electronic commerce platform by the sponsored customer service representatives.

5. The method of claim 4, wherein the compensation operation calculates a compensation amount from the periodic fees derived from sponsored customer service representatives based upon a unilevel compensation model.

6. The method of claim 4, wherein the compensation operation calculates a compensation amount from the period fees derived from sponsored customer service representatives based upon a matrix compensation model.

7. The method of claim 4, wherein the compensation operation calculates a compensation amount from the period fees derived from sponsored customer service representatives based upon a stair-step breakaway compensation model.

8. The method of claim 1 further comprising
charging the seller a service fee for additional services provided by the customer service representative not directly associated with the listing of the product; and
compensating the customer service representative with a portion of the service fee.

9. The method of claim 8 further comprising compensating the customer service representative with portions of service fees paid by additional sellers on the electronic commerce platform associated with sponsored customer service representatives introduced to the electronic commerce platform by the customer service representative.

10. The method of claim 9 further comprising compensating the customer service representative with portions of service fees paid by other additional sellers on the electronic commerce platform associated with additional sponsored customer service representatives introduced to the electronic commerce platform by the sponsored customer service representatives.

11. A method for incentivizing provision of sales assistance services by customer service representatives to sellers of products or services on an electronic commerce platform, without inflating product pricing with commission fees or artificially lowering product pricing, and thereby increasing a number of sellers participating on the electronic commerce platform, the method comprising the following steps performed on a computer server system hosting the electronic commerce platform:
receiving a registration from a seller for access to the electronic commerce platform;
receiving a listing of a product or service for sale by the seller on the electronic commerce platform;
associating the registration from the seller with a customer service representative indicated as providing assistance services to the seller in listing the product or service for sale on the electronic commerce platform;
charging the seller a service fee for additional services provided by the customer service representative not directly associated with the listing of the product or service on the electronic commerce platform;
processing a transaction for a purchase of the product or service;
remitting all funds received from the purchase of the product or service to the seller; and
compensating the customer service representative for the assistance services with a portion of the service fee rather than a transaction fee on the funds received from the purchase, thereby avoiding impact to product or service pricing while still incentivizing the provision of sales assistance services by the customer service representative to the seller by providing compensation.

12. The method of claim 11 further comprising compensating the customer service representative with portions of service fees paid by additional sellers on the electronic commerce platform associated with sponsored customer service representatives introduced to the electronic commerce platform by the customer service representative.

13. The method of claim 12 further comprising compensating the customer service representative with portions of service fees paid by other additional sellers on the electronic commerce platform associated with additional sponsored customer service representatives introduced to the electronic commerce platform by the sponsored customer service representatives.
